(19) United States
(12) Patent Application Publication
(10) Pub. No.: US 2016/0091930 A1
(43) Pub. Date: Mar. 31, 2016

(54) TOUCH DISPLAY DEVICE AND METHOD FOR LAUNCHING TOUCH PANEL OF TOUCH DISPLAY DEVICE

(71) Applicant: Acer Incorporated, New Taipei City (TW)

(72) Inventors: Chang-Hsu Chen, New Taipei City (TW); Chih-Chiang Chen, New Taipei City (TW); Chueh-Pin Ko, New Taipei City (TW)

(21) Appl. No.: 14/582,189

(22) Filed: Dec. 24, 2014

(30) Foreign Application Priority Data
Sep. 25, 2014 (TW) 103133217

(51) Int. Cl. G06F 1/16; G06F 3/041

(52) U.S. Cl. CPC G06F 1/1654; G06F 3/041; G06F 2203/04103

(57) ABSTRACT

A touch display device including a touch panel, a display device, a plurality of first connecting terminals, and a plurality of second connecting terminals is provided. The display device is opposite to the touch panel. The first connecting terminals are disposed on the touch panel. The second connecting terminals are disposed on the display device, wherein the second connecting terminals are physically connected to the first connecting terminals such that the display device and the touch panel are electrically connected. A method for launching the touch panel of the touch display device is also provided.

### CROSS-REFERENCE TO RELATED APPLICATION

This application claims the priority benefit of Taiwan application serial no. 103133217, filed on Sep. 25, 2014. The entirety of the above-mentioned patent application is hereby incorporated by reference herein and made a part of this specification.

### BACKGROUND OF THE INVENTION

1. Field of the Invention

The invention relates to a touch display device and a method for launching touch panel of touch display device.

2. Description of Related Art

In recent years, various applications for information technology, wireless mobile communication and information appliances have been rapidly developed. In order to satisfy the requirements of convenience in carrying, light weight, and user-friendly operations, input devices used in various information products have been changed from conventional keyboards or mice to touch panels.

Currently, in a common touch display device, a touch panel and a display device are individually manufactured before assembling the two together. During an assembly process, the touch panel must be bonded to a flexible printed circuit (FPC) first, then the FPC is bended so as to insert pins of the FPC into connectors of the display device. This assembling method not only consumes time, but also leads to damages on elements disposed on the FPC, and thereby lowering a reliability of the overall system and causing electrical property problems. Therefore, it has become one of important problems to be solved by developers in the field as how to improve an assembly efficiency while preventing the elements from damages during assembly or disassembly.

### SUMMARY OF THE INVENTION

The invention provides a touch display device, which is capable of improving the assembly efficiency of the touch panel and the display device while preventing the elements from damages during assembly or disassembly.

The invention also provides a method for launching the touch panel of the touch display device.

A touch display device of the invention includes a touch panel, a display device, a plurality of first connecting terminals, and a plurality of second connecting terminals. The display device is opposite to the touch panel. The first connecting terminals are disposed on the touch panel. The second connecting terminals are disposed on the display device, wherein the second connecting terminals are physically connected to the first connecting terminals such that the display device and the touch panel are electrically connected.

A method for launching touch panel of touch display device of the invention includes the following. A touch panel and a display device are provided. A plurality of first connecting terminals are disposed on the touch panel, and a plurality of second connecting terminals are disposed on the display device. Whether the touch panel and the display device are in a connecting state is determined. When determining that the touch panel and the display device are in the connecting state, a touch sensing function of the touch panel is launched.

Based on the above, according to the embodiments of the invention, the first connecting terminals and the second connecting terminals for connecting the touch panel and the display device are directly disposed on the touch panel and the display device respectively, such that the touch panel and the display device may be directly bonded through the first connecting terminals and the second connecting terminals. Accordingly, the touch display device according to the embodiments of the invention is capable of providing the ideal assembly efficiency while preventing the elements on the FPC from damages during assembly and disassembly thereby causing issues regarding the reliability and the electrical property. Moreover, a method for launching the touch panel of the touch display device is also provided in the invention.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a touch display device before assembly according to a first embodiment of the invention.

FIG. 2A is a cross-sectional view of the touch display device before assembly according to the first embodiment of the invention.

FIG. 2B is a cross-sectional view of the touch display device after assembly according to the first embodiment of the invention.

FIG. 3A is a cross-sectional view of another touch display device before assembly according to the first embodiment of the invention.

FIG. 3B is a cross-sectional view of the another touch display device after assembly according to the first embodiment of the invention.

FIG. 4 is a flowchart of a method for launching touch panel of touch display device according to the first embodiment of the invention.

FIG. 5 is a top view of a touch display device before assembly according to a second embodiment of the invention.

FIG. 6 is a flowchart of a method for launching touch panel of touch display device according to the second embodiment of the invention.

FIG. 7 is a top view of a touch display device before assembly according to a third embodiment of the invention.

FIG. 8 is a flowchart of a method for launching touch panel of touch display device according to the third embodiment of the invention.

FIG. 9 is a cross-sectional view of the touch display device after assembly according to a fourth embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

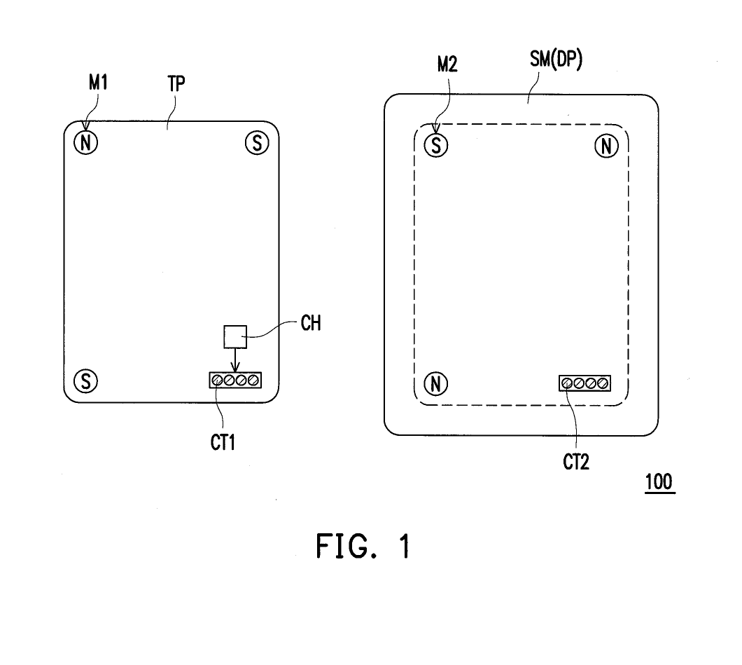

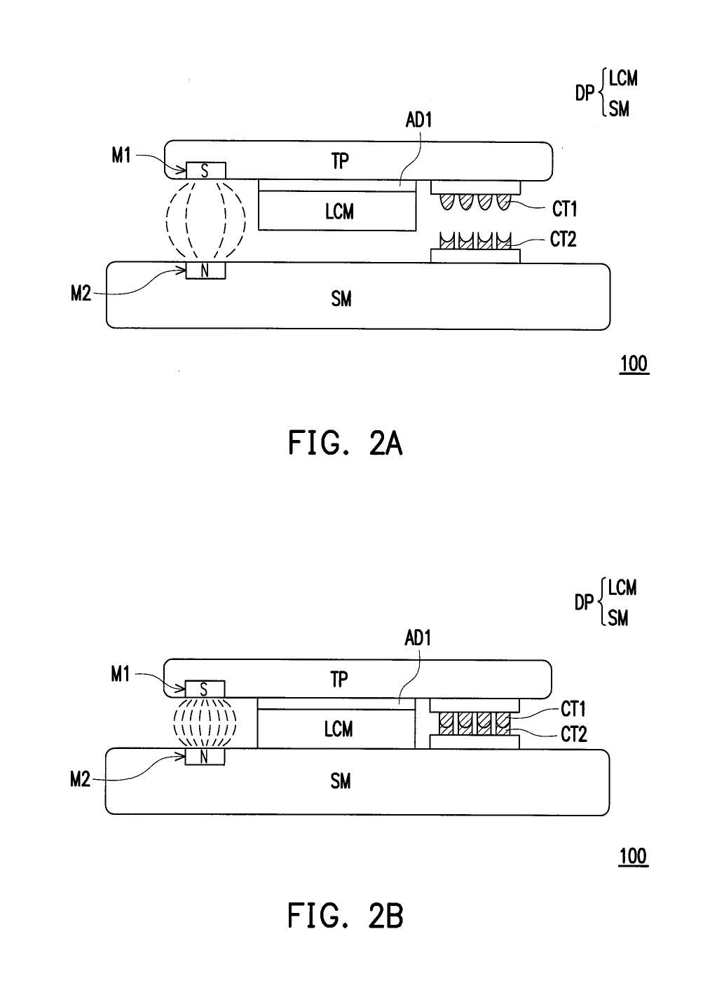

FIG. 1 is a top view of a touch display device before assembly according to a first embodiment of the invention. For clarity of the description, a touch panel and a display device are separately illustrated in FIG. 1. FIG. 2A is a cross-sectional view of the touch display device before assembly according to the first embodiment of the invention. FIG. 2B is a cross-sectional view of the touch display device after assembly according to the first embodiment of the invention. Referring to FIG. 1 to FIG. 2B, a touch display device 100 includes a touch panel TP, a display device DP, a plurality of first connecting terminals CT1, and a plurality of second connecting terminals CT2.

The touch panel TP may be, for example, a capacitive touch panel, a resistance touch panel, an optical touch panel or touch panels in other forms. Take the capacitive touch panel for example, in which the touch panel TP may include an electrode array, a plurality of wires and at least one substrate configured to carry the electrode array and the wires (which are not illustrated). The wires may include a plurality of signal lines which are electrically connected to the electrode array and at least one grounding line for shielding signal interferences or resisting electrostatic discharge.

The display device DP is opposite to the touch panel TP. The display device DP may be a liquid crystal display device, an organic electro-luminescence display device, an electrophoretic display device, a plasma display device, an electrowetting display device, a field emission display device, or display devices in other forms. Take the liquid crystal display device for example, in which the display device DP may include a system module SM and a display module LCM. The system module SM includes, for example, a backlight module and a circuit board and so on (which are not illustrated). The display module LCM is disposed on the system module SM, and includes, for example, an active device array substrate, an opposite substrate opposite to the active device array substrate, and a display medium disposed between the active device array substrate and the opposite substrate (which are not illustrated).

The first connecting terminals CT1 are disposed on the touch panel TP, and the first connecting terminals CT1 are electrically connected to the wires in the touch panel TP, so as to transmit and receive signals of the touch panel TP. The second connecting terminals CT2 are disposed on the display device DP, and disposed corresponding to the first connecting terminals CT1. Specifically, the first connecting terminals CT1 and the second connecting terminals CT2 have the same amount. Further, the first connecting terminals CT1 are disposed on a surface of the touch panel TP close to the display device DP, the second connecting terminals CT2 are disposed on a surface of the display device DP close to the touch panel TP, and the second connecting terminals CT2 and the display module LCM are located on the same side of the system module SM. In addition, an orthographic projection of each of the first connecting terminals CT1 on the display device DP at least partially covers an orthographic projection of the corresponding second connecting terminal CT2 on the touch panel DP, such that the display device DP and the touch panel TP may be electrically connected by physically connecting the first connecting terminals CT1 and the second connecting terminals CT2 together. A direction for connecting the first connecting terminals CT1 to the second connecting terminals CT2 is, for example, perpendicular to the display device DP as shown in FIG. 2A and FIG. 2B, but the invention is not limited thereto. In another embodiment, the direction for connecting the first connecting terminals CT1 to the second connecting terminals CT2 may also be parallel to the display device DP.

A material of the first connecting terminals CT1 and the second connecting terminals CT2 may be selected from materials capable of transmitting signals. For instance, the material of the first connecting terminals CT1 and the second connecting terminals CT2 may be selected from metals or metal alloys with good conductivity. In the present embodiment, the first connecting terminals CT1 and the second connecting terminals CT2 are elastically contacted. For instance, each of the first connecting terminals CT1 is a male terminal of a pogo pin, and each of the second connecting terminals CT2 is a female terminal of the pogo pin, but the invention is not limited thereto. In another embodiment, each of the first connecting terminals CT1 may be the female terminal of the pogo pin, and each of the second connecting terminals CT2 may be the male terminal of the pogo pin.

Based on different disposition positions of a chip for controlling the touch panel TP, a transmission format and a detection method for touch signals of the touch panel TP may also be different. As shown in FIG. 1, the touch display device 100 further includes a chip CH. The chip CH is disposed on the touch panel TP and electrically connected to the first connecting terminals CT1. In such design, the transmission format of the touch signals between the first connecting terminals CT1 and the second connecting terminals CT2 may be universal serial bus (USB), inter-integrated circuit (I2C), serial peripheral interface (SPI) or other suitable transmission formats.

By directly disposing the first connecting terminals CT1 and the second connecting terminals CT2 (for connecting the touch panel TP and the display device DP together) on the touch panel TP and the display device DP respectively, the assembly process may be simplified (e.g., the step of bending the FPC may be omitted) to provide the ideal assembly efficiency. In addition, issues regarding the reliability and the electrical property due to damages on the elements disposed on the FPC caused by bending the FPC during assembly or disassembly in the conventional art may also be prevented.

Moreover, the touch display device 100 may further include magnetic devices installed in the touch panel TP and the display device DP, so as to assist in alignment and fool-proofing when connecting the first connecting terminals CT1 and the second connecting terminals CT2 together. Specifically, the touch display device 100 may further include a plurality of first magnetic elements M1 embedded in the touch panel TP and a plurality of second magnetic elements M2 embedded in the system module SM of the display device DP. Each of the second magnetic elements M2 is aligned to one of the first magnetic elements M1, and the aligned first magnetic element M1 and the second magnetic element M2 have different magnetic poles. For instance, when the first magnetic element M1 is N-pole, the corresponding magnetic element M2 is S-pole. On the other hand, when the first magnetic element M1 is S-pole, the corresponding magnetic element M2 is N-pole.

FIG. 1 schematically illustrates one of polarity designs for each of the first magnetic elements M1 and each of the second magnetic elements M2. However, the invention is not intended to limit amounts, the polarity designs and the disposition method for the first magnetic elements M1 and the second magnetic elements M2, and it falls within the scope of the present invention for which protection is sought as long as the first magnetic elements M1 and the second magnetic elements M2 can help to reduce alignment time and increase alignment precision. For instance, the first magnetic elements M1 and the second magnetic elements M2 may also be directly attached on the touch panel TP and the system module SM of the display device DP respectively. In addition, the first magnetic elements M1 and the second magnetic elements M2 may also be disposed on locations on the touch panel TP corresponding to the first connecting terminals CT1 and locations on the display device DP corresponding to the second connecting terminal CT2 respectively.

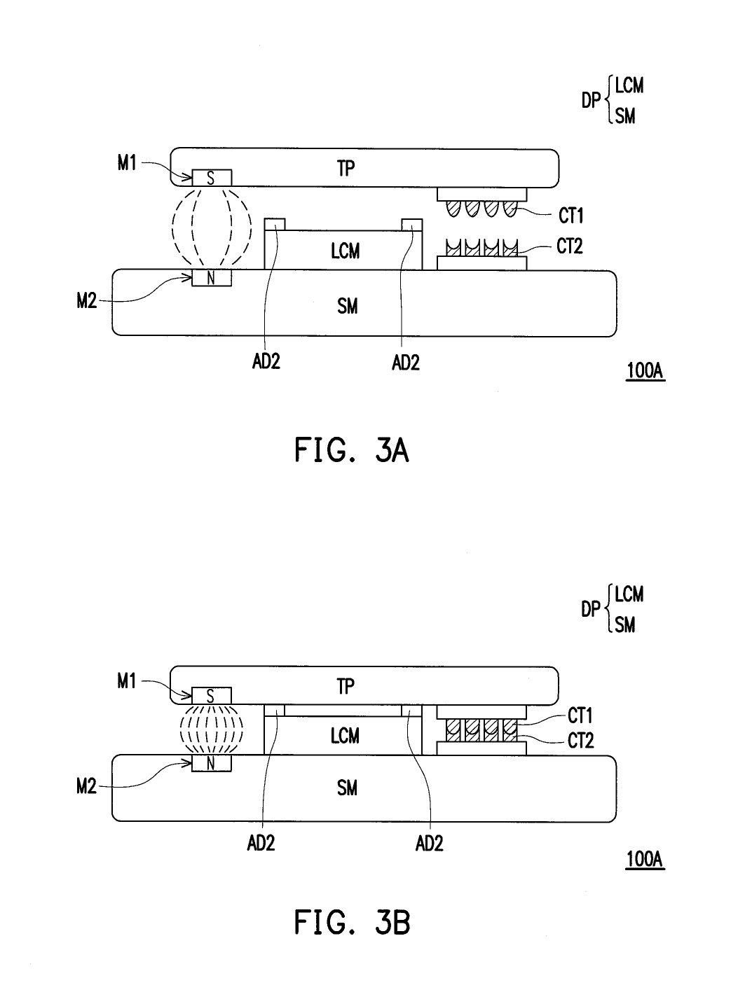

In FIG. 2A and FIG. 2B, before the touch panel TP and the display device DP are bonded, the display module LCM is attached in advance on one side of the touch panel TP facing the system module SM through an adhesion layer AD1, and the adhesion layer AD1 is, for example, fully covered on a region where the display module LCM and the touch panel TP are bonded. That is, an area of the adhesion layer AD1 is equal to an area where the display module LCM and the touch panel TP are bonded, but the invention is not limited to the above. FIG. 3A is a cross-sectional view of another touch display device before assembly according to the first embodiment of the invention. FIG. 3B is a cross-sectional view of the another touch display device after assembly according to the first embodiment of the invention. As shown in FIG. 3A and FIG. 3B, before the touch panel TP and the display device DP are bonded, the display module LCM may also be disposed in advance on one side of the system module SM facing the touch panel TP. Besides, an adhesion layer AD2 may be formed on one side of the display module LCM facing the touch panel TP. Accordingly, after the touch panel TP and the display device DP are bonded, the display module LCM and the touch panel TP may be tightly bonded together. The adhesion layer AD2 is, for example, disposed along a circumference of the display module LCM. That is, an area of the adhesion layer AD2 is smaller than an area where the display module LCM and the touch panel TP are bonded, but the invention is not limited to the above either.

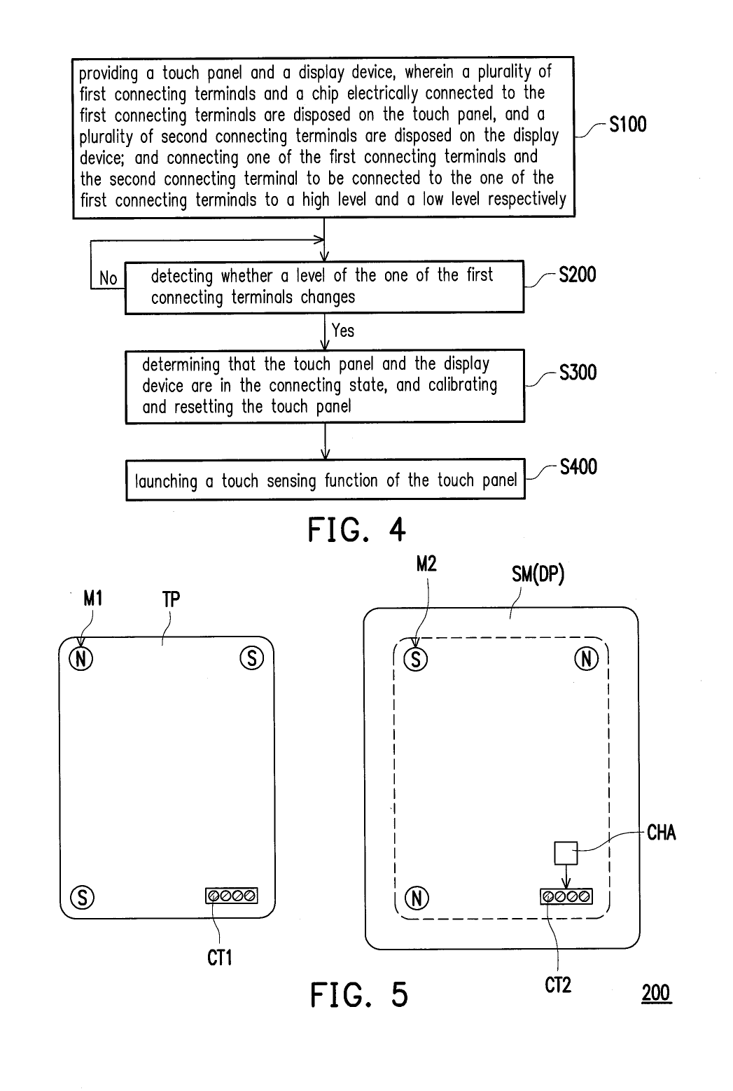

Hereinafter, a method for launching the touch panel TP of the touch display device 100, 100A is introduced by reference with FIG. 4. FIG. 4 is a flowchart of a method for launching touch panel of touch display device according to the first embodiment of the invention. Referring to FIG. 1 to FIG. 4, when the chip CH is installed on the touch panel TP, the chip CH is instantly driven at the time when the touch panel TP and the display device DP are electrically connected. Therefore, a connecting state of the touch panel TP and the display device DP may be determined by the connecting terminals (including the first connecting terminals CT1 and the second connecting terminals CT2) in the present embodiment. For instance, the connecting state of the touch panel TP and the display device DP may be obtained by connecting one specific first connecting terminal CT1 and a corresponding second connecting terminal CT2 to a high level and a low level, and then detecting whether a level of the specific first connecting terminal CT1 changes.

Specific steps are as shown in FIG. 4, first, a touch panel TP and a display device DP are provided, wherein a plurality of first connecting terminals CT1 and a chip CH electrically connected to the first connecting terminals CT1 are disposed on the touch panel TP, and a plurality of second connecting terminals CT2 are disposed on the display device DP. One of the first connecting terminals CT1 and the second connecting terminal CT2 to be connected to the one of the first connecting terminals CT1 are connected to a high level and a low level respectively (step S100). For instance, the one of the first connecting terminals CT1 is connected to the high level, and the second connecting terminal CT2 to be connected to the one of the one of the first connecting terminals CT1 is connected to the low level, but the invention is not limited thereto. Herein, the first connecting terminal CT1 connected to the high level and the second connecting terminal CT2 connected to the low level are, for example, merely used to determine the connecting state of the touch panel TP and the display device DP, and the rest of the first connecting terminals CT1 and the second connecting terminals CT2 are used to transmit the touch signals.

Subsequently, whether a level of the one of the first connecting terminals CT1 changes is determined (step S200). When determining that the level of the one of the first connecting terminals CT1 changes, it is determined that the touch panel TP and the display device DP are in the connecting state. When determining that the touch panel TP and the display device DP are in the connecting state, a touch sensing function of the touch panel TP is launched (step S400). After determining that the touch panel TP and the display device DP are in the connecting state, and before the touch sensing function of the touch panel TP is launched (step S400), the touch panel may be selectively calibrated and reset (step S300).

The foregoing embodiment is merely one of possible implementations for the touch display device according to the invention, and a method of determining whether the touch panel TP and the display device DP are in the connecting state is not limited to the above. In the structure where the chip CH is disposed on the touch panel TP, any methods of determining whether the touch panel TP and the display device DP are in the connecting state are applicable to the scope of the invention.

FIG. 5 is a top view of a touch display device before assembly according to a second embodiment of the invention. Referring to FIG. 5, a touch display device 200 is substantially identical to the touch display device 100 of FIG. 1, and the same elements are indicated by the same reference numbers, thus relative disposition relations and effects of the elements are not repeated hereinafter. A major difference between the touch display device 200 and the touch display device 100 is that, in the touch display device 200, a chip CHA for controlling the touch panel TP is disposed on the display device DP and electrically connected to the second connecting terminals CT2. Further, the touch panel TP is electrically connected to the chip CHA through the first connecting terminals CT1 and the second connecting terminals CT2. In such structure, because the chip CHA stays in a power-on state once the display device DP is turned on, a software or a hardware is required in order to determine whether the touch panel TP and the display device DP are in the connecting state. A method of determining whether the touch panel TP and the display device DP are in the connecting state by using the software is introduced as follows.

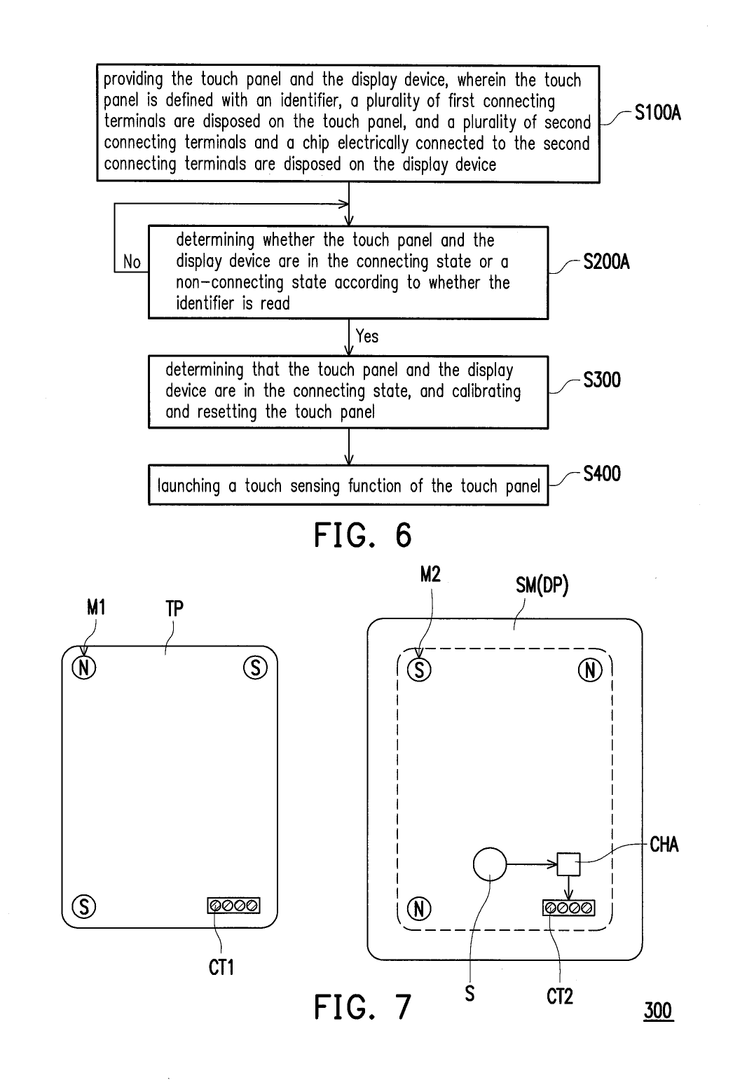

FIG. 6 is a flowchart of a method for launching touch panel of touch display device according to the second embodiment of the invention. Referring to FIG. 6, first, the touch panel TP and the display device DP of FIG. 5 are provided, wherein the touch panel TP is defined with an identifier (ID), a plurality of first connecting terminals CT1 are disposed on the touch panel TP, and a plurality of second connecting terminals CT2 and a chip CHA electrically connected to the second connecting terminals CT2 are disposed on the display device DP (step S100A). The chip CHA determines whether the touch panel TP and the display device DP are in the connecting state or a non-connecting state according to whether the identifier of the touch panel TP is read from the software (step S200A). When the identifier is read by the chip CHA, it is determined that the touch panel TP and the display device DP are in the connecting state, and a touch sensing function of the touch panel TP is launched (step S400). Naturally, after determining that the touch panel TP and the display device DP are in the connecting state, and before the touch sensing function of the touch panel TP is launched (step S400), the touch panel may also be selectively calibrated and reset (step S300).

In the embodiment of FIG. 5 and FIG. 6, whether the touch panel TP and the display device DP are in the connecting state is determined by the software, but the invention is not limited thereto. FIG. 7 is a top view of a touch display device before assembly according to a third embodiment of the invention. Referring to FIG. 7, a touch display device 300 is substantially identical to the touch display device 200 of FIG. 5, and the same elements are indicated by the same reference numbers, thus relative disposition relations and effects of the elements are not repeated hereinafter. A major difference between the touch display device 300 and the touch display device 200 is that, the touch display device 300 further includes a sensor S. The sensor S is disposed on the display device DP and electrically connected to the chip CHA, and the sensor S is configured to detect a connecting state of the touch panel TP and the display device DP. For instance, the sensor S may be a Hall sensor, a light sensor, a pressure sensor, or other suitable sensors.

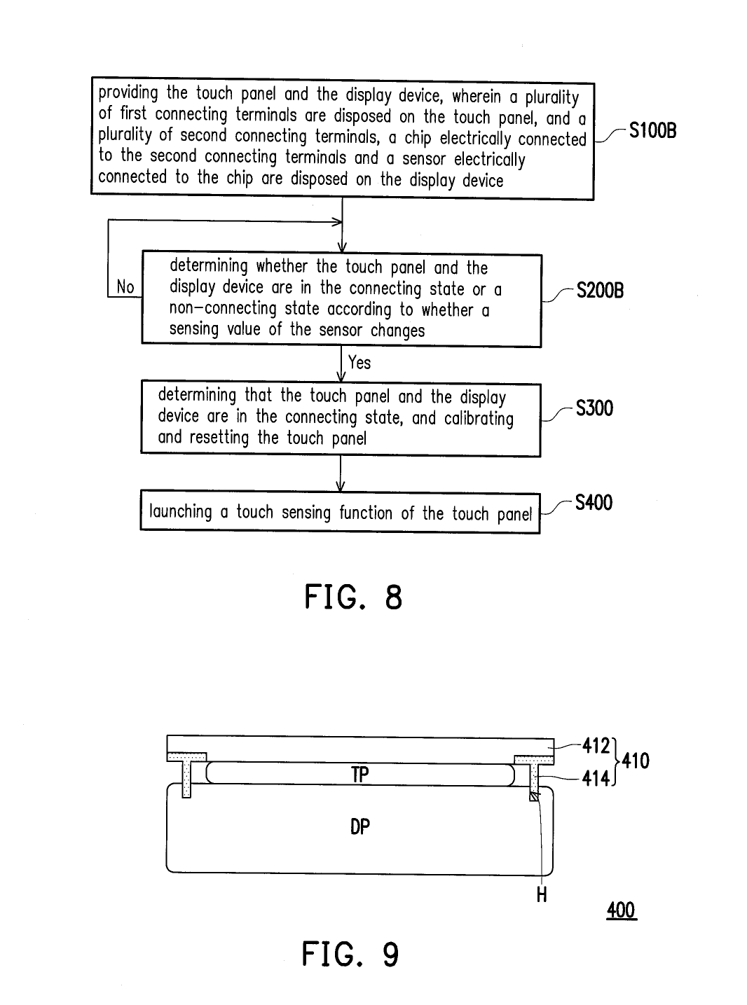

A method of determining whether the touch panel TP and the display device DP are in the connecting state by using the hardware (e.g., the sensor S) is introduced as follows. FIG. 8 is a flowchart of a method for launching touch panel of touch display device according to the third embodiment of the invention. Referring to FIG. 8, first, the touch panel TP and the display device DP of FIG. 7 are provided, wherein a plurality of first connecting terminals CT1 are disposed on the touch panel TP, and a plurality of second connecting terminals CT2, a chip CHA electrically connected to the second connecting terminals CT2 and a sensor S electrically connected to the chip CHA are disposed on the display device DP (step S100B). The chip CHA determines whether the touch panel TP and the display device DP are in the connecting state or a non-connecting state according to whether a sensing value of the sensor S changes (step S200B). For instance, whether the touch panel TP and the display device DP are in the connecting state may be determined according conditions such as increases in magnetic force, reduction of light intensity (even approach to zero) or increases in pressure. When the chip CHA detects that the sensing value of the sensor S changes, it is determined that the touch panel TP and the display device DP are in the connecting state, and a touch sensing function of the touch panel TP is launched (step S400). Naturally, after determining that the touch panel TP and the display device DP are in the connecting state, and before the touch sensing function of the touch panel TP is launched (step S400), the touch panel may also be selectively calibrated and reset (step S300).

In addition, based on different design requirements, other elements may further be disposed in the touch display devices of the foregoing embodiments. FIG. 9 is a cross-sectional view of the touch display device after assembly according to a fourth embodiment of the invention. In FIG. 9, illustrations of the first connecting terminals CT1, the second connecting terminals CT2, the chips CH and CHA, the first magnetic elements M1 and the second magnetic elements M2 are omitted. Referring to FIG. 9, a touch display device 400 is substantially identical to the touch display devices 100, 100A, 200 and 300 as described above. The elements of the touch display device 400 which are not illustrated may be disposed with reference to the structures of the touch display devices 100, 100A, 200 and 300, and thus relative disposition relations and effects of the elements are not repeated hereinafter. A major difference between the touch display device 400 and the touch display devices 100, 100A, 200 and 300 is that, the touch display device 400 further includes a cover plate structure 410. The cover plate structure 410 is opposite to the touch panel TP, and the touch panel TP is disposed between the cover plate structure 410 and the display device DP.

The cover plate structure 410 includes a cover plate 412 and a plurality of engaging elements 414. The cover plate 412 may be a hard substrate having a high mechanical strength for protecting the elements covered thereby (e.g., for scratch-resistant). The engaging elements 414 are respectively connected to the cover plate 412. The engaging elements 414 and the cover plate 412 may be connected together by methods of bonding, engaging or embedding, and a relative disposition relation of the engaging elements 414 and the cover plate 412 is not limited by what illustrated in FIG. 9. In addition, the display device DP includes a plurality of connection holes H disposed corresponding to the engaging elements 414, and the cover plate structure 410 are bonded to connection holes H of the display device DP through the engaging elements 414. Accordingly, the cover plate 412 and the display device DP may be assembled together in a detachable manner, so as to improve convenience in assembling and maintaining of the display device 400.

In summary, according to the embodiments of the invention, the dispositions of the first connecting terminals and the second connecting terminals may be used to simplify the assembly process of the touch panel and the display device in order to improve the assembly efficiency. In addition, because the first connecting terminals and the second connecting terminals are directly disposed on the touch panel and the display device respectively, issues regarding the reliability and the electrical property due to damages on the elements disposed on the FPC caused by bending the FPC during assembly or disassembly in the conventional art may also be prevented. Moreover, a method for launching the touch panel of the touch display device is also provided in the invention.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display device, comprising:
a touch panel;
a display device, opposite to the touch panel;
a plurality of first connecting terminals, disposed on the touch panel; and
a plurality of second connecting terminals, disposed on the display device, wherein the second connecting terminals are physically connected to the first connecting terminals such that the display device and the touch panel are electrically connected.

2. The touch display device according to claim 1, wherein the second connecting terminals and the first connecting terminals are elastically contacted.

3. The touch display device according to claim 1, wherein each of the first connecting terminals is a male terminal of a pogo pin and each of the second connecting terminals is a female terminal of the pogo pin, or each of the first connecting terminals is the female terminal of the pogo pin and each of the second connecting terminals is the male terminal of the pogo pin.

4. The touch display device according to claim 1, wherein a direction for connecting the second connecting terminals to the first connecting terminals is perpendicular to the display device.

5. The touch display device according to claim 1, wherein a direction for connecting the second connecting terminals to the first connecting terminals is parallel to the display device.

6. The touch display device according to claim 1, further comprising:
a plurality of first magnetic elements, embedded in the touch panel; and
a plurality of second magnetic elements, embedded in the display device, wherein each of the second magnetic elements is aligned to one of the first magnetic elements, and the aligned first magnetic element and the second magnetic element have different magnetic poles.

7. The touch display device according to claim 1, further comprising:
a chip, configured to control the touch panel, and the chip being disposed on the touch panel and electrically connected to the first connecting terminals.

8. The touch display device according to claim 1, further comprising:
a chip, configured to control the touch panel, the chip being disposed on the display device and electrically connected to the second connecting terminals, and the touch panel being electrically connected to the chip through the first connecting terminals and the second connecting terminals.

9. The touch display device according to claim 8, further comprising:
a sensor, disposed on the display device and electrically connected to the chip, and configured to detect a connecting state of the touch panel and the display device.

10. The touch display device according to claim 9, wherein the sensor is a Hall sensor, a light sensor, or a pressure sensor.

11. The touch display device according to claim 1, further comprising:
a cover plate structure, opposite to the touch panel, the touch panel being disposed between the cover plate structure and the display device, the cover plate structure comprising a cover plate and a plurality of engaging elements, the engaging elements being respectively connected to the cover plate, and the display device having a plurality of connection holes, wherein the cover plate structure is bonded to the connection holes of the display device through the engaging elements.

12. A method for launching touch panel of touch display device, comprising:
providing a touch panel and a display device, a plurality of first connecting terminals being disposed on the touch panel, and a plurality of second connecting terminals being disposed on the display device;
determining whether the touch panel and the display device are in a connecting state; and
when determining that the touch panel and the display device are in the connecting state, launching a touch sensing function of the touch panel.

13. The method for launching touch panel of touch display device according to claim 12, wherein a chip electrically connected to the first connecting terminals is further disposed on the touch panel.

14. The method for launching touch panel of touch display device according to claim 13, wherein a method of determining whether the touch panel and the display device are in the connecting state comprises:
connecting one of the first connecting terminals and the second connecting terminal to be connected to the one of the first connecting terminals to a high level and a low level respectively;
detecting whether a level of the one of the first connecting terminals changes; and
when determining that the level of the one of the first connecting terminals changes, determining that the touch panel and the display device are in the connecting state.

15. The method for launching touch panel of touch display device according to claim 12, wherein a chip electrically connected to the second connecting terminals is further disposed on the display device.

16. The method for launching touch panel of touch display device according to claim 15, wherein the touch panel is defined with an identifier, and a method of determining whether the touch panel and the display device are in the connecting state comprises:
determining whether the touch panel and the display device are in the connecting state or a non-connecting state according to whether the identifier is read; and
when the identifier is received, determining that the touch panel and the display device are in the connecting state.

17. The method for launching touch panel of touch display device according to claim 15, wherein a sensor electrically connected to the chip is further disposed on the display device, and a method of determining whether the touch panel and the display device are in the connecting state comprises:
determining whether the touch panel and the display device are in the connecting state or a non-connecting state according to whether a sensing value of the sensor changes; and
when detecting that the sensing value of the sensor changes, determining that the touch panel and the display device are in the connecting state.

18. The method for launching touch panel of touch display device according to claim 17, wherein the sensor is a Hall sensor, a light sensor, or a pressure sensor.
